(19) United States
(12) Patent Application Publication
(10) Pub. No.: US 2008/0019725 A1
(43) Pub. Date: Jan. 24, 2008

(54) Peripheral unit, image forming apparatus and image forming system using the same

(76) Inventors: Junichi Iida, Kawasaki-shi (JP); Kenji Yamada, Kawasaki-shi (JP); Junichi Tokita, Yokohama-shi (JP); Shingo Matsushita, Yokohama-shi (JP); Naohiro Kikkawa, Kawasaki-shi (JP); Hiroshi Kubo, Kawasaki-shi (JP)

Correspondence Address: HARNESS, DICKEY & PIERCE, P.L.C., P.O. BOX 8910, RESTON, VA, 20195, US

(21) Appl. No.: 11/826,431

(22) Filed: Jul. 16, 2007

(30) Foreign Application Priority Data
Jul. 14, 2006 (JP) 2006-193961
Feb. 22, 2007 (JP) 2007-042565

(51) Int. Cl. G03G 15/00; G03G 21/00

(52) U.S. Cl. 399/75

(57) ABSTRACT

A peripheral unit is disclosed including a pre-processing device for performing a pre-processing process, or a post-processing device for performing a post-processing process, wherein the peripheral unit is connectable to an image forming apparatus and has multiple preparatory operation patterns in relation to power and time.

### PRIORITY STATEMENT

The present patent application claims priority under 35 U.S.C. §119 upon Japanese patent applications No. JP2006-193961 filed on Jul. 14, 2006; and No. JP2007-042565 filed on Feb. 22, 2007 in the Japan Patent Office, the entire contents of each of which is hereby incorporated herein by reference.

### BACKGROUND

1. Field

Embodiment of the present invention generally relate to a peripheral unit, an image forming apparatus and/or an image formation system using the peripheral unit and/or the image forming apparatus.

2. Discussion of the Background

Typically, with regard to a finisher (post-processing unit) including post-processing portions which perform post-processing actions to a sheet on which an image is formed, the preparation actions (preparatory operations), for example, moving a portion in the finisher to a ready position, is performed when a power is on or a cover is closed.

Published unexamined Japanese patent application No. 2005-148479 describes a technology for a finisher (post-processing unit) in which the preparatory operations of each processing portion are performed in an arbitral order.

However, in the technology, since the preparatory operations for post processing are sequentially performed according to the arbitral order, a certain amount of time and electric power are consumed before all the preparatory operations of all the processing portions are finished.

To an image formation system where peripheral units (pre-processing units and/or post-processing units) are connected to an image forming apparatus, there are different demands depending on the type and the combination of the connected peripheral units and the image forming apparatus. For example, the preparatory operations of peripheral units are required to be complete simultaneously with the preparatory operation of an image forming apparatus regardless of the time consumed for the preparatory operations, or an image forming apparatus is demanded to be ready for photocopying process before the preparatory operations of the peripheral units start. Also, depending on the preparatory operations of an image forming apparatus, there are margins in light of the consumption of electric power. This extra electricity can be used for the preparatory operations for peripheral units.

When the preparatory operations of multiple processing portions in the image formation and the preparatory operations of peripheral units are performed at the same time, there is a drawback in that the timing of peak electricity for initialization operation for both of the preparatory operations overlaps.

### SUMMARY

Because of these reasons, the present inventors recognize that a need exists for a peripheral unit, an image forming apparatus and an image formation system which can select improved or even optimal preparatory operations with a free latitude of system designing and performance sequence.

Accordingly, in at least one embodiment of the present invention a peripheral unit, an image forming apparatus and/or an image formation system is provided which can select improved or even optimal preparatory operations with a free latitude of system designing and performance sequence. In at least one embodiment, a peripheral unit includes a pre-processing device for performing a pre-processing process, or a post-processing device for performing a post-processing process, connectable to an image forming apparatus and including multiple preparatory operation patterns in relation to power and time.

As another aspect of at least one embodiment of the present invention, an image forming apparatus is provided which includes a recognition device for recognizing the type of a peripheral unit. In addition, when at least one peripheral unit described above is connected to the image forming apparatus, the image forming apparatus is used to select a preparatory operation pattern from the multiple preparatory operation patterns for each peripheral unit and to make each peripheral unit perform the preparatory operation therefor.

As another aspect of at least one embodiment of the present invention, an image forming apparatus is provided which includes a recognition device for recognizing the type of a peripheral unit. In addition, the image forming apparatus of at least one embodiment may include multiple preparatory operation patterns in relation to power and time, may select a preparatory operation therefrom and may perform the preparatory operation pattern based on types and combinations of peripheral units connected to the image forming apparatus.

In at least one embodiment, the image forming apparatus described above may include preset multiple preparatory operation patterns based on types and combinations of the connected peripheral units, may specify a preparatory operation pattern according to the type and the combination of the peripheral units and may make the peripheral units perform a preparatory operation therefor.

As another aspect of at least one embodiment of the present invention, an image formation system is provided which includes at least one peripheral unit described above and the image forming apparatus described above.

These and other objects, features and advantages of the present invention will become apparent upon consideration of the following description of the example embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description of example embodiments when considered in connection with the accompanying drawings in which like reference characters designate like corresponding parts throughout and wherein:

FIG. 1 is a diagram illustrating a control block chart of an embodiment of a post processing unit related to an embodiment of the present invention;

FIG. 2 is a diagram illustrating a flow chart of preparatory operations in multiple operation processing of post processing units;

FIG. 3 is a diagram illustrating a flow chart of preparatory operations in parallel (separate) operation processing of post processing units;

FIG. 4 is an enlarged diagram illustrating the center-folding unit illustrated in FIG. 6;

FIG. 5 is a flow chart illustrating the preparatory operation of the center-folding unit;

FIG. 6 is a schematic diagram illustrating an embodiment of the post-processing units related to an embodiment of the present invention;

FIG. 7 is a flow chart illustrating an embodiment of the preparatory operation of the post-processing unit;

FIG. 8 is a schematic diagram illustrating an example of the type and the configuration of the image formation system related to an embodiment of the present invention;

FIG. 9 is a diagram illustrating an example of the preparatory operation patterns in relation to power and time;

FIG. 10 is a diagram illustrating another example of the preparatory operation patterns in relation to power and time;

FIG. 11 is a diagram illustrating another example of the preparatory operation patterns in relation to power and time;

FIG. 12 is a schematic diagram illustrating another example of the type and the configuration of the image formation system related to an embodiment of the present invention;

FIG. 13 is a diagram illustrating another example of the preparatory operation patterns in relation to power and time;

FIG. 14 is a diagram illustrating another example of the preparatory operation patterns in relation to power and time;

FIG. 15 is a schematic diagram illustrating another example of the type and the configuration of the image formation system related to an embodiment of the present invention;

FIG. 16 is a diagram illustrating another example of the preparatory operation patterns in relation to power and time; and

FIG. 17 is a diagram illustrating another example of the preparatory operation patterns in relation to power and time.

### DETAILED DESCRIPTION OF EXAMPLE EMBODIMENTS

Although the terms first, second, etc. may be used herein to describe various elements, components, regions, layers and/or sections, it should be understood that these elements, components, regions, layer and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this invention is not intended to be limited to the specific terminology so selected and it is to be understood that each specific element includes all technical equivalents that operate in a similar manner.

Referring now to the drawings, wherein like reference numerals designate identical or corresponding parts throughout the several views, example embodiments of the present invention are described. However, the present invention is not limited to the example embodiments as illustrated in the drawings.

The present invention will be described below in detail with reference to several example embodiments and accompanying drawings.

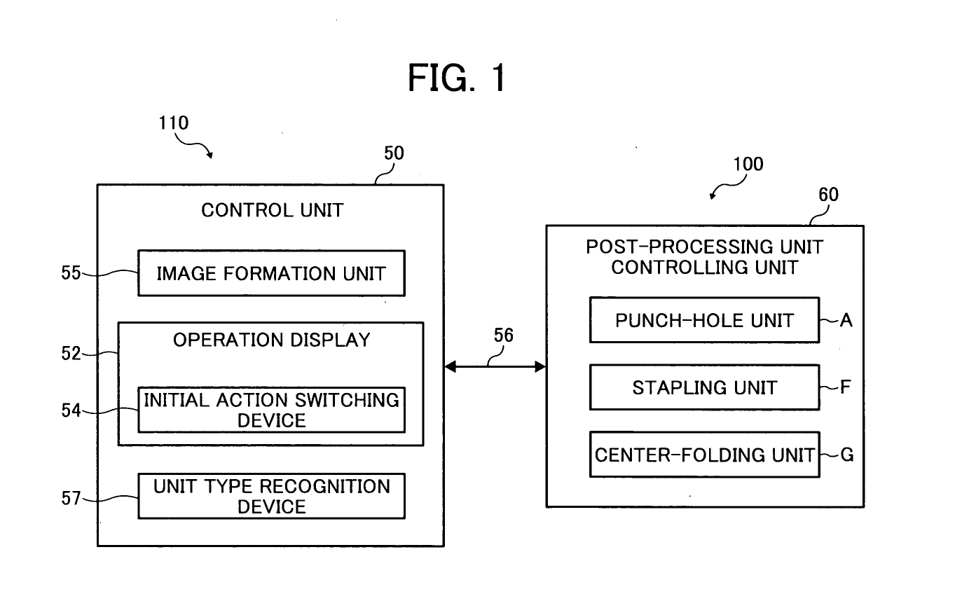

One embodiment of the present invention is described in detail with reference to FIGS. 1 to 6.

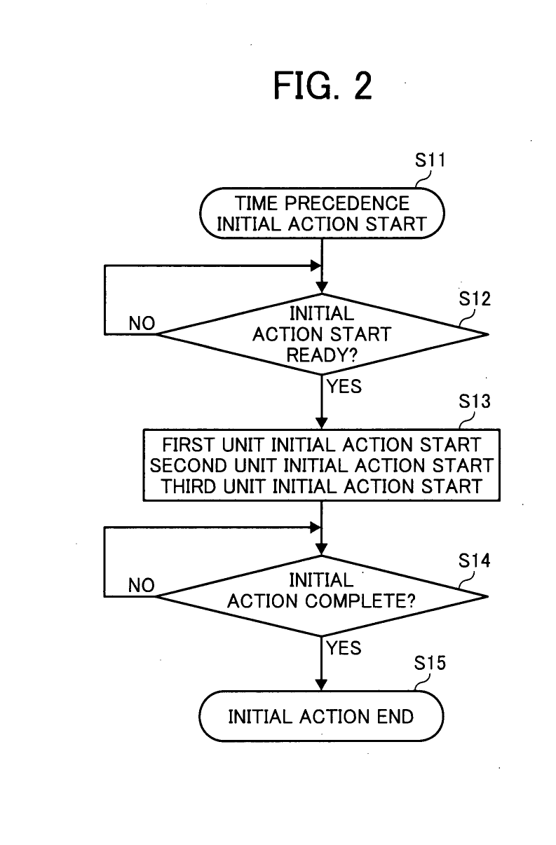

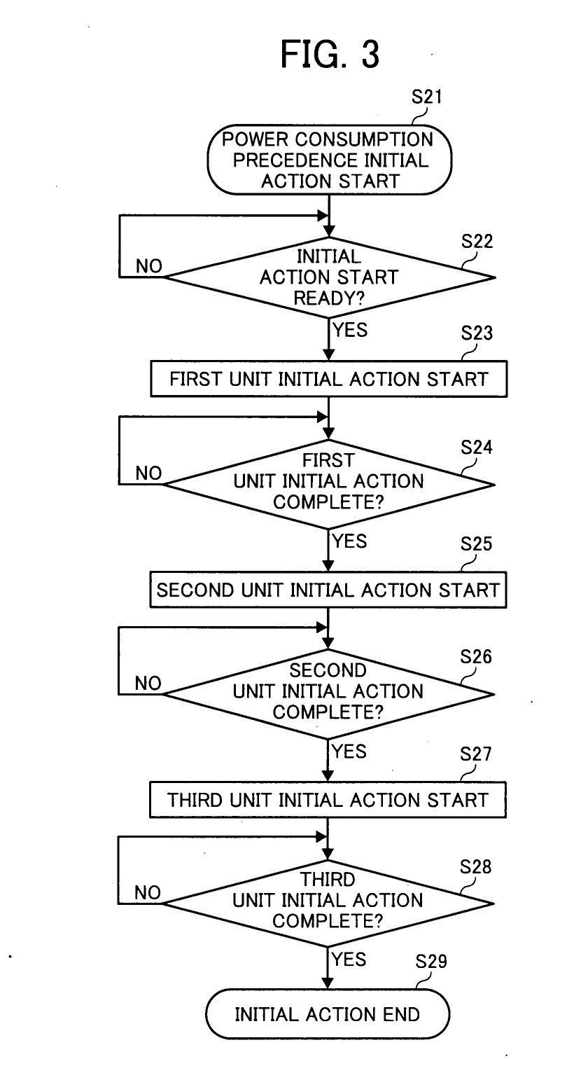

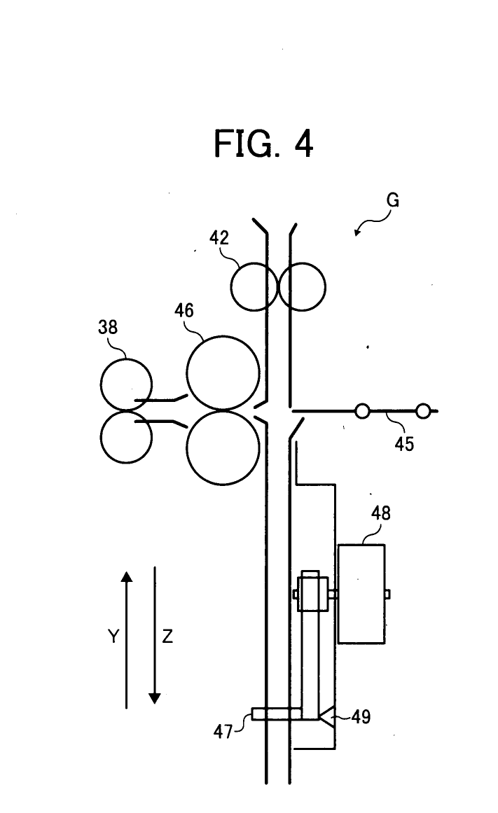

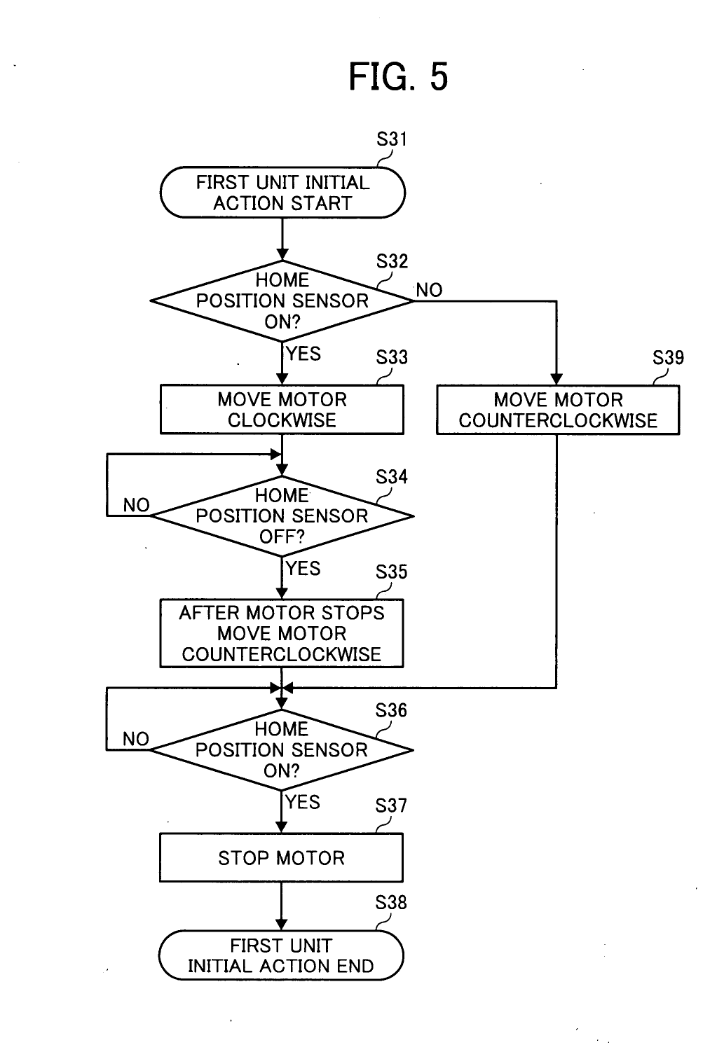

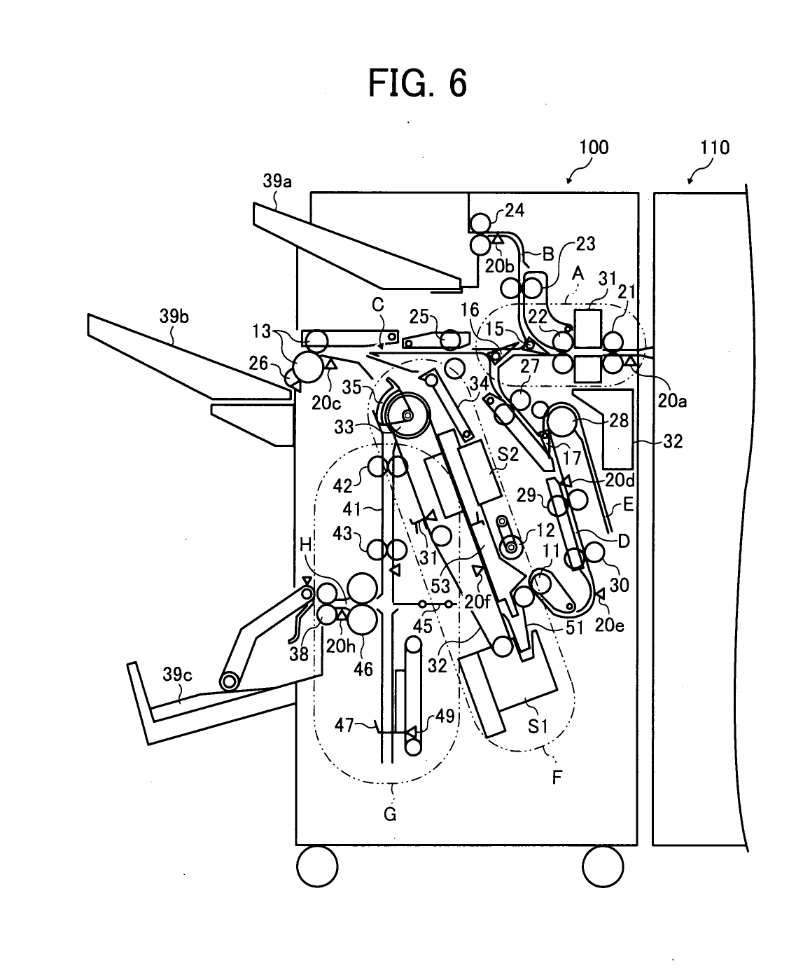

FIG. 1 is a control block chart of image formation and post processing. FIG. 2 is a flow chart illustrating a case of parallel (multiple) preparatory operations of post-processing units. FIG. 3 is a flow chart illustrating a case of sequential (separate) preparatory operations of post-processing units. FIG. 4 is an enlarged diagram illustrating the center-folding portion illustrated in FIG. 6. FIG. 5 is a flow chart illustrating the preparatory operation of the center-folding portion. FIG. 6 is a schematic diagram illustrating a post-processing (finishing) apparatus related to the embodiment.

As illustrated in FIG. 6, a post-processing unit 100 is attached to the side of an image forming apparatus 110 and provided with a punch-hole processing unit A for punching holes in a sheet discharged from the image forming apparatus 100, a stapling unit (staple tray) F for stapling a bundle of sheets, a center-folding unit G for center-folding the bundle of stapled sheets, and discharging trays 39A, 39B and 39C for discharging the bundle of stapled and folded sheets out of the post-processing unit 100.

In this embodiment, the image forming apparatus 110 and the post-processing unit 100 form an image formation system.

In the punch-hole processing unit A, an entrance sensor 20a for detecting a sheet from the image forming apparatus 110, an entrance roller 21 provided downstream thereof, a punching unit 31, a hopper 32, a conveying roller 22, and separation pawls 15 and 16 are arranged in this order. When a solenoid is powered on, the separation pawl 15 pivots upward and the separation pawl 16 pivots downward. The separation pawls 15 and 16 guide a sheet to a paper path B to the discharging tray 39a, a paper path C to the discharging tray 39b and a paper path D to the stapling unit F.

On the route of the paper path B, a conveyor roller 23, a discharging roller 24 and a discharging sensor 20b are provided and a sheet on the paper path B is guided to the discharging tray 39a. On the route of the paper path C, a conveyor roller 25, discharging rollers 13 and 26 and a discharging sensor 20c are provided to guide a sheet finished with punch-hole processing and stapling processing on the paper path C to the discharging tray 39b. On the route of the paper path D, respective conveying rollers 27, 29 and 30, sheet detection sensors 20d and 20e are provided to guide a sheet to the stapling unit F. A separation pawl 17 is also provided on the paper path D and guides a sheet to a sheet accommodation portion E by the conveying roller 28. The sheet stays in the sheet accommodation portion E so that the sheet can be overlapped with the next sheet and conveyed.

Next, the stapling unit F will be described. The stapling unit F includes a staple discharging roller 11, a rear end fence 51 where a sheet guided into the tray is stopped, a detection sensor 20f that detects a sheet on the tray, a rapping roller 12 for aligning the longitudinal direction (transferring direction) of sheets, a jogger fence 53 for aligning the latitudinal direction of sheets, a stapler S1 for stapling the end of a bundle of sheets, a stapler S2 for stapling the center portion of a bundle of sheets, a discharging pawl 31 for discharging a bundle of stapled sheets, a discharging belt 36 for driving the discharging pawl 31, a discharging roller 33 for driving the discharging belt 36, and a separation guiding board 34 and a movable guide 35 for deflecting the transfer direction of the bundle of sheets. The separation guiding board 34 can pivot around its supporting point. The movable guide 35 is attached to the discharging roller 33 such that the movable guide 35 can pivot therearound.

Next, the center folding unit G is described. The center-folding unit G includes a transfer guide 41 for guiding a bundle of sheets along the path, transfer rollers 42 and 43 for transferring the bundle of sheets along the transfer guide 41, a folding blade 45 provided in a protrudable manner, and a pair of folding rollers 46 for folding the bundle of sheets pressed by the folding blade 45. On the bottom end of the center folding unit G, there are provided a rear end fence 47 to which the rear end of the bundle of sheets transferred is stopped, a driving motor 48 for moving the rear end fence 47 up and down, and a home position detection sensor 49 for detecting the preparatory position (home position) of the rear end fence 47. The bundle of sheets folded by the pair of folding rollers 46 passes through a sheet detection sensor 20h and a discharging roller 38 situated on a paper path H and is discharged to the discharging tray 39c.

Next, the control block chart of a post-processing unit related to an embodiment of the present invention is described. As illustrated in FIG. 1, the post-processing unit 100 has a post-processing unit controlling unit 60 for controlling each of the driving portions of the punch-hole processing unit A, the stapling unit F and the center-folding unit G. The post-processing unit 100 is connected to a control unit 50 of the image forming apparatus 110 via a communication device 56. The image forming apparatus 110 is provided with an image formation unit 55 for performing image formation on a sheet, an operation display 52 where various kinds of settings related to image formation can be made, and a unit type recognition device 57 for recognizing the type of the post-processing unit 100. The operation display 52 has a preparatory operation switching device 54 for switching (selecting) the settings of parallel (multiple) operation processing and sequential (separate) operation processing.

Next, the function of the post-processing unit related to embodiments of the present invention is described. When the power of the post-processing unit 100 is turned on, each processing unit therein starts preparatory operations. As an example of the preparatory operations, the preparatory operation of the center-folding unit G (the first unit) is described with reference to FIGS. 4 and 5.

As illustrated in FIG. 5, when the first step (S31) of the preparatory operation of the center-folding unit G starts, it is detected in the next step (S32) whether or not the rear end fence 47 is at the position of the home position detection sensor 49. In the step S32, when the status of the home position detection sensor 49 is determined to be ON, a driving motor is rotated clockwise in the next step (S33) to move the rear end fence 47 in Y direction indicated in FIG. 4. In the next step (S34), it is determined whether or not the home position detection sensor 49 is OFF. When the status of the home position detection sensor 49 is determined to be OFF, the driving motor is turned off and is rotated counterclockwise in the next step (S35) to move the rear end fence 47 to Z direction indicated in FIG. 4.

In the step S32, when the status of the home position detection sensor 49 is determined to be OFF, the driving motor is rotated counterclockwise in the next step (S39) to move the rear end fence 47 to Z direction. The next step (S36) starts after the rear end fence 47 is moved. In the step (S36), when the status of the home position detection sensor 49 is determined to be ON, the driving motor is stopped to complete the preparatory operation of the center-folding unit G.

The preparatory operation is controlled according to the preparatory operation processing set at the operation display 52 of the image forming apparatus 110. When the parallel (multiple) operation processing is selected at the operation display 52, the preparatory operation is operated according to the flow chart illustrated in FIG. 2. When the sequential (separate) operation processing is selected at the operation display 52, the preparatory operation is operated according to the flow chart illustrated in FIG. 3.

In the case of the parallel operation processing (time precedence processing), when the step (S11) of the preparatory operation starts, it is determined in the next step (S12) whether or not the preparatory operation can be started. When it is determined that the preparatory operation is ready to start, the next step (S13) starts. In the step (S13), each of the preparatory operations of the center-folding unit G (first unit), the punch-hole processing unit A (second unit) and the stapling unit F (third unit) is performed at the same time. It is determined in the next step (S14) whether or not the preparatory operations have been finished. When all the preparatory operations are finished, the steps of the parallel operation processing terminate (S15).

In the case of the sequential operation processing (power consumption precedence), when the step (S21) of the preparatory operation starts, it is determined in the next step (S22) whether or not the preparatory operation of the center folding unit G (first unit) can be started. When it is determined that the preparatory operation thereof is ready to start, the preparatory operation of the center folding unit G starts in the next step (S23). In the next step (S24), it is determined whether or not the preparatory operation of the center folding unit G is finished. When the preparatory operation thereof is finished, the next step (S25) starts. When the preparatory operation of the center folding unit G is not finished, the action of the step (S24) is repeated.

In the step (S25), the preparatory operation of the punch-hole processing unit A (second unit) starts. In the next step (S26), it is determined whether or not the preparatory operation of the punch-hole processing unit A is finished. When the preparatory operation thereof is finished, the next step starts and when the preparatory operation is not complete, the action of step (S26) is repeated. In the step (S27), the preparatory operation of the stapling unit F (third unit) starts and in the step (S28), it is determined whether or not the preparatory operation of the stapling unit F is finished. When the preparatory operation thereof is finished, the next step (S29) starts and when the preparatory operation is not complete, the action of Step (S28) is repeated. When the preparatory operation of the stapling unit F is complete, the sequential operation processing terminates in the step (S29).

In this embodiment, the post-processing unit 100 performs two kinds of operation processing, i.e., sequential (separate) operation processing and parallel (multiple) operation processing. The multiple operation processing is performed only to a post-processing unit which is free from trouble with the multiple operation processing and the preparatory operation time can be shortened. In addition, for a post-processing unit which has trouble with the multiple operation processing, the separate operation processing is performed while varying the power consumption. Therefore, the preparatory operation for a unit (e.g., heating a fixing device) in the image forming apparatus 110 can be shortened. Such a unit is convenient because optimal operation processing can be performed according to the type of the post-processing unit.

To the operation display 52, a preparatory operation switching device 54 is provided that can switch the setting of a multiple operation processing to and from the setting of a separate operation processing. That is, the setting is easily changed at the operation display 52.

Next, another embodiment is described. In the description below, the same numeral references are applied to the portions having the same function as those in the embodiment mentioned above and their detailed description is omitted. The differences between the embodiments are mainly described below.

In this embodiment, the image forming apparatus 110 recognizes the post-processing unit 100 and controls the preparatory operations based on the type of the post-processing unit 100. Different preparatory operations (hereinafter referred to as system 1) are performed according to the type of the post-processing unit 100 or the same preparatory operation (hereinafter referred to as system 2) is performed regardless of the type thereof. The system 1 and the system 2 can be switched at the operation display 52.

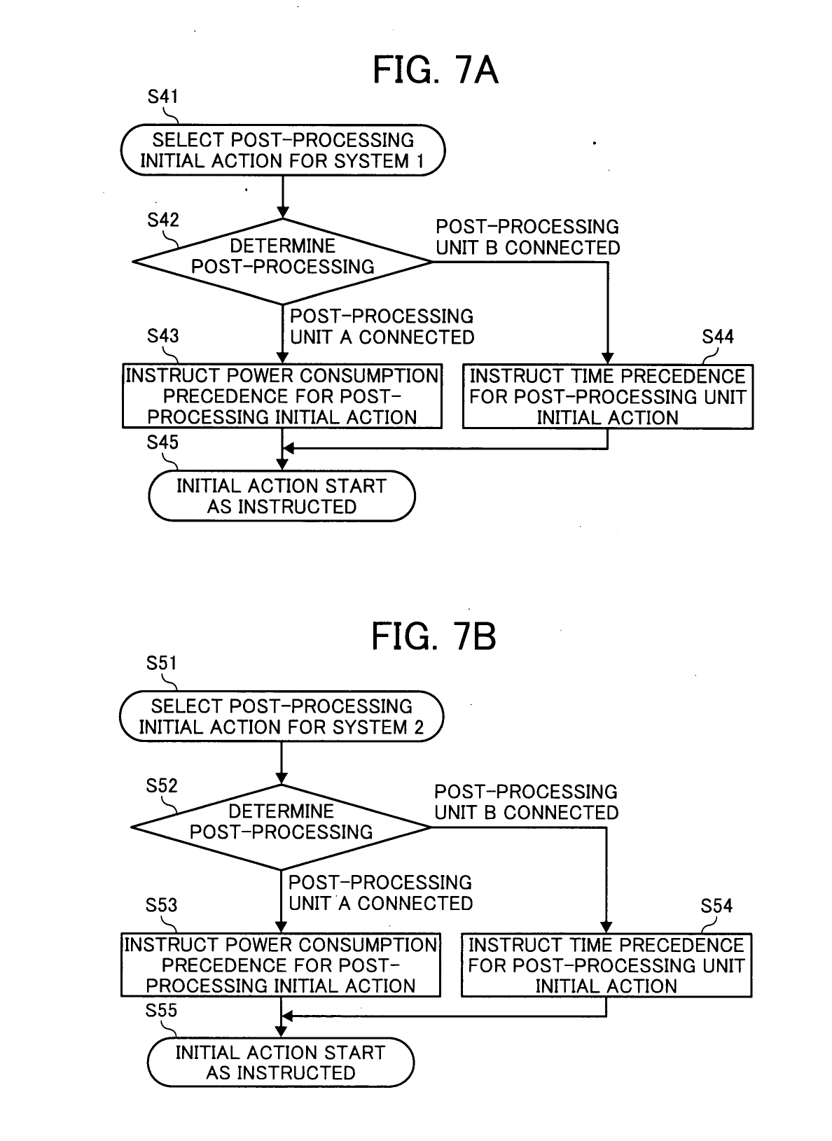

FIG. 7A is a flow chart illustrating the case of the system 1. As illustrated in FIG. 7A, when the step (S41) starts upon the selection of the system 1, a type recognition device 57 of the image forming apparatus 110 recognizes the type of the post-processing unit 100 in the step (S42). In this step, when the image forming apparatus 110 recognizes, for example, a post-processing unit type A having processing portions that consume great power for their preparatory operation, the image forming apparatus 110 provides an instruction to perform the separate preparatory operation for power consumption precedence (step S43). On the other hand, in the step (S42), when the image forming apparatus 110 recognizes, for example, a post-processing unit type B having processing portions that consume small power for the preparatory operation, the image forming apparatus 110 provides an instruction to perform the multiple preparatory operation for time precedence in the step (S44). Based on the operation processing instructed at the next step (S45), the preparatory operation starts.

FIG. 7B is a flow chart illustrating the case of system 2. As illustrated in FIG. 7B, when the system 2 is selected and the step (S51) starts, the type of the post-processing unit is determined in the next step (S52). In this step, when the image forming apparatus 110 recognizes, for example, the post-processing unit type A, the image forming apparatus 110 provides an instruction to perform the separate preparatory operation for power consumption precedence (step S53). On the other hand, in the step (S52), when the image forming apparatus 110 recognizes, for example, the post-processing unit type B, the image forming apparatus 110 also provides an instruction to perform the separate preparatory operation for time precedence in the step (S54). Based on the operation processing instructed at the next step (S55), the preparatory operation starts.

In this embodiment, when the post-processing unit 100 is connected to the image forming apparatus 110, the type of the post-processing unit 100 is recognized and the preparatory operation thereof is performed according to the type of the post-processing unit post-processing unit 100. This system is furthermore convenient.

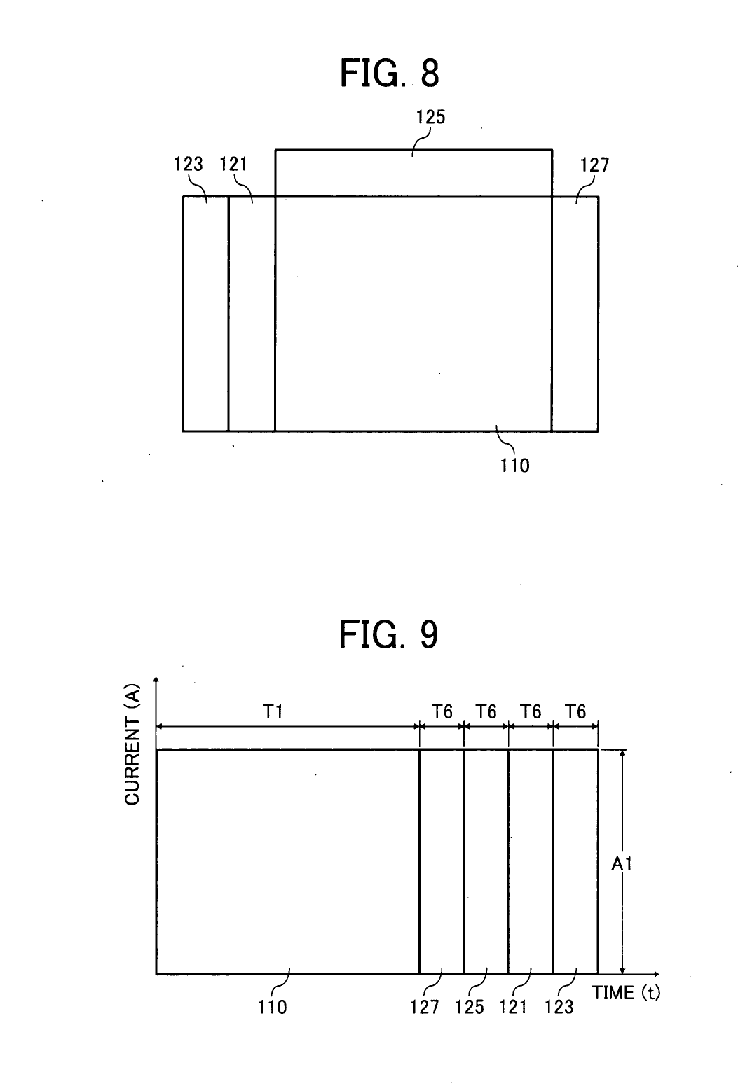

Next, another embodiment is described with reference to FIGS. 8 to 11. As illustrated in FIG. 8, in the system of this embodiment, a first post-processing unit 121, a second post-processing unit 123, and pre-processing units, i.e., an automatic document feeder (ADF) 125 and a sheet feeder 127 are attached to the image forming apparatus 110. The first post-processing unit 121 is, for example, a hole-punching unit, and the second post-processing unit 121 is, for example, a stapling unit.

The image forming apparatus 110 in this embodiment has three preparatory operation patterns. The first preparatory operation pattern is, as illustrated in FIG. 9, a pattern of preparatory operations of each portion in the image forming apparatus 110, which are positioning of the image scanning portion and heating of the fixing device with a current of A1 (e.g., 6 A) for T1 (e.g., 8 seconds).

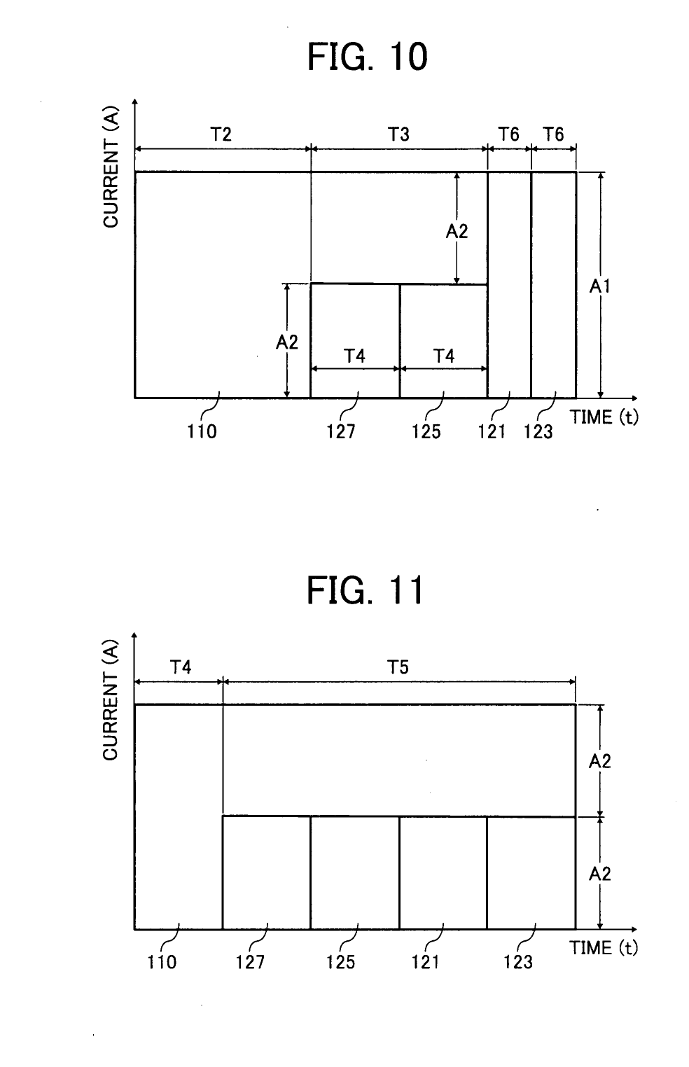

The second preparatory operation pattern of the image forming apparatus 110 is, as illustrated in FIG. 10, a pattern of preparatory operations of heating by a current of A1 for T2 (e.g., 4 seconds) followed by a current of A2 (e.g., 3 A) for T3 (e.g., 4 seconds).

The third preparatory operation pattern of the image forming apparatus 110 is, as illustrated in FIG. 11, a pattern of preparatory operations of heating by a current of A1 for T4 (e.g., 2 seconds) followed by a current of A2 for T5 (e.g., 8 seconds).

Each of the peripheral units 121, 123, 125 and 127 has two preparatory operation patterns. These are the first preparatory operation pattern of a current of A1 for T6 (e.g., 1 second) as illustrated in FIG. 9 and the second preparatory operation pattern of a current of A2 for T4 (e.g., 2 seconds) as illustrated in FIG. 11.

In this embodiment, according to various kinds of combination of the preparatory operation patterns of the image forming apparatus 110 and the preparatory operation patterns of each of the peripheral units 121, 123, 125 and 127, the preparatory operation of the image formation system as a whole can be optimally performed based on the request of a customer.

For example, the preparatory operation pattern illustrated in FIG. 9 is that, after the image forming apparatus 110 has performed the preparatory operation therefor with a current of A1 for T1, the respective preparatory operations are performed for the sheet feeder 127, the automatic document feeder 125, the first post-processing unit 121 and the second post-processing unit 123 with a current of A1 for T6 in this order. Namely, the image forming apparatus takes precedence over the peripheral units as to the preparatory operations in light of the entire image formation system.

In the preparatory operation pattern illustrated in FIG. 10, when the preparatory operation of the image forming apparatus 110 is complete, the preparatory operations of the sheet feeder 127 and the automatic document handler 125 are complete as well. That is, when the image forming apparatus 110 is ready for operation, it is possible to start the photocopying process.

In the preparatory operation pattern illustrated in FIG. 11, when the preparatory operation of the image forming apparatus 110 is complete, the preparatory operations of all of the peripheral units 127, 125, 121 and 123 are complete.

In this embodiment, when the preparatory operation pattern of the image forming apparatus 110 and each preparatory operation pattern of the peripheral units 121, 123, 125 and 127 are used in combination, the image formation system can perform preparatory operations with wide selections of preparatory operation patterns.

The first to third patterns are set after each peripheral unit 127, 125, 121 and 123 is connected to the image forming apparatus 110 by selecting a pattern from the three patterns set beforehand. This setting can be done by, for example, a field engineer, upon setting of the image forming apparatus 110.

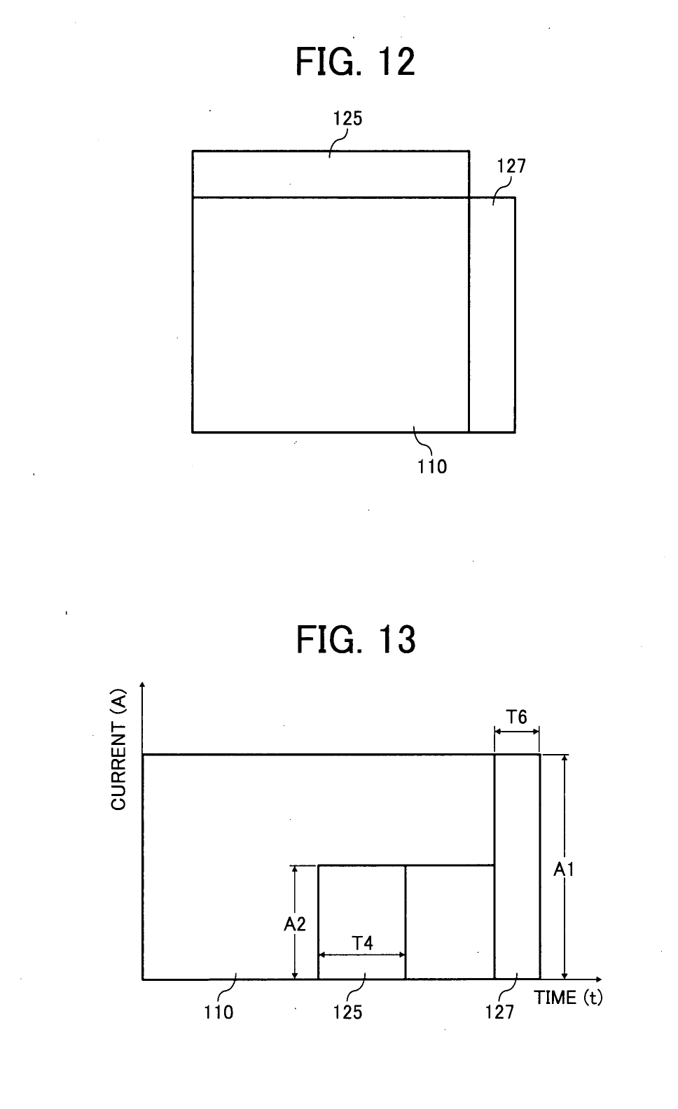

Another embodiment is described with reference to FIGS. 12 to 14. In this embodiment, the image forming apparatus 110 performs the preparatory operation pattern set for each peripheral unit connected thereto according to the type of 127, 125, 121 and 123 by the operation signals. When the image forming apparatus 110 illustrated in FIG. 12 performs the above-mentioned second preparatory operation pattern, the second preparatory operation pattern for a peripheral unit is used for the automatic document handler 125 using the extra capacity of the current for the image forming apparatus 110 and the first preparatory operation pattern is used for the sheet feeder 127.

In addition, when the image forming apparatus 110 has enough extra consumption current, the third preparatory operation pattern for the peripheral unit is used for the sheet feeder 127 and the automatic document handler 125 as illustrated in FIG. 14. The third preparatory operation pattern for the peripheral units is performed with a current of A3 (for example, 1.5 A) for T2 (for example, 4 seconds).

Namely, in this embodiment, each of the peripheral units 127, 125, 121 and 123 has the third preparatory operation pattern as illustrated in FIG. 14.

Preparatory operation patterns preset based on combinations of the types of peripheral units connected to the image forming apparatus 110 are recorded in the image forming apparatus 110. When the image forming apparatus 110 recognizes the peripheral units 127, 125, 121 and 123 connected thereto, the image forming apparatus 110 performs its own preparatory operation specified for the combination. Furthermore, the image forming apparatus 110 also selects the preparatory operation patterns set for the peripheral units and provides instructions thereto.

The preparatory operation illustrated in FIG. 14 is relatively quickly finished in comparison with the preparatory operation illustrated in FIG. 3 in light of preparatory operations of the entire image formation system.

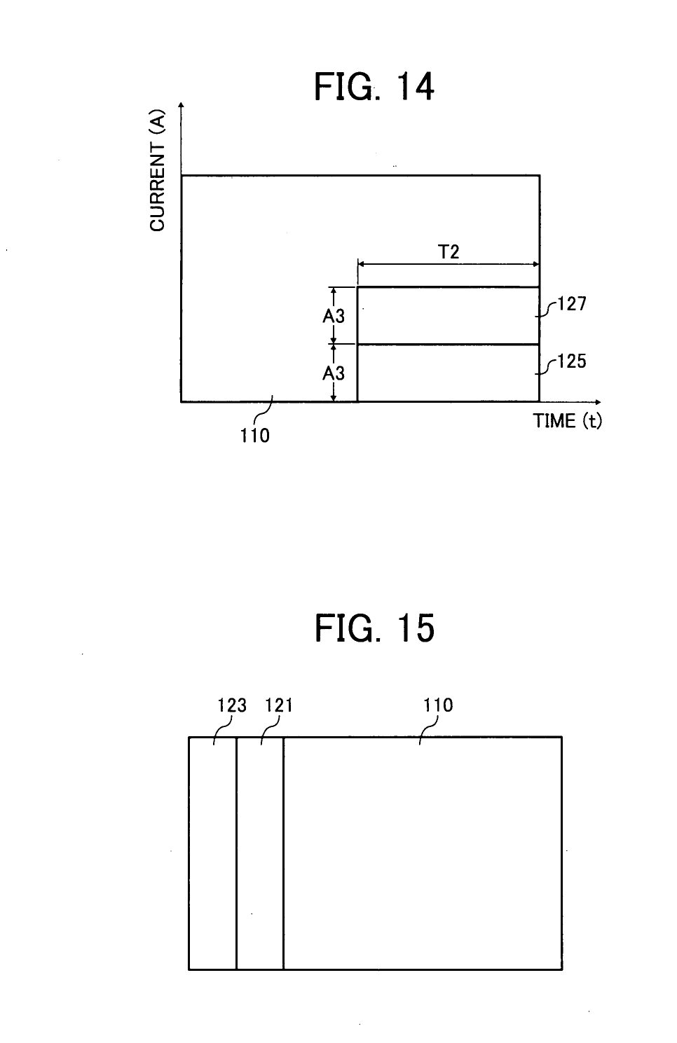

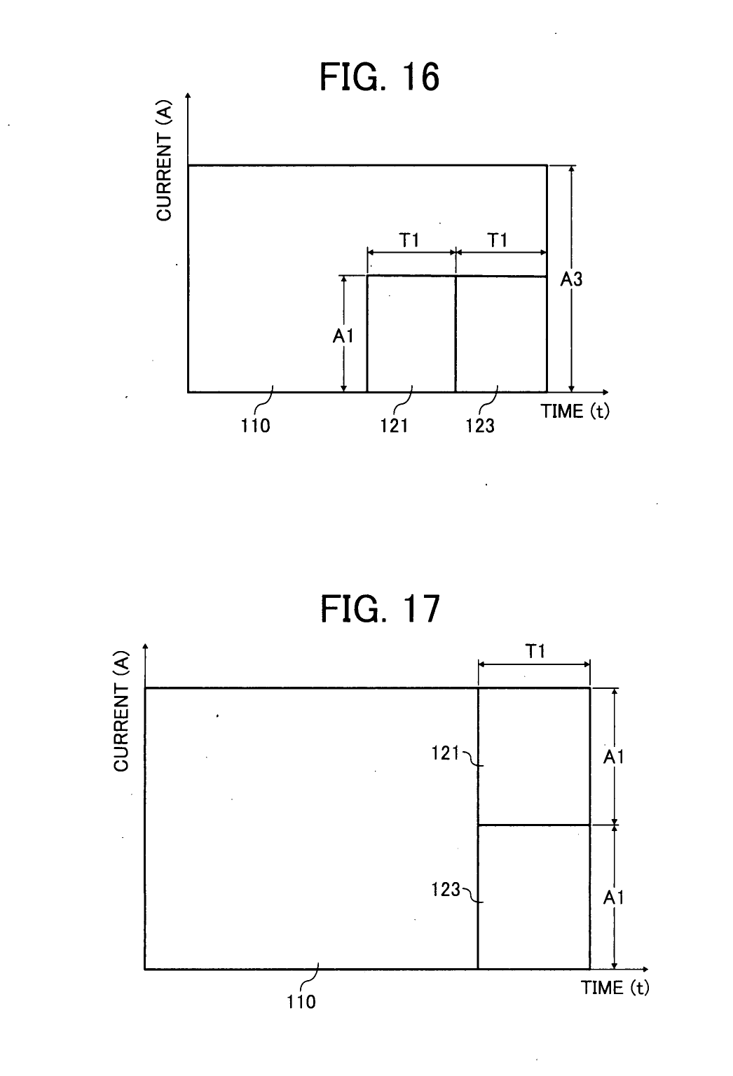

Another embodiment is described with reference to FIGS. 15 to 17. In this embodiment, the image forming apparatus 110 has two preparatory operation patterns mentioned above, i.e., the second preparatory operation pattern (refer to FIG. 16) and the first preparatory operation pattern (refer to FIG. 17). The peripheral units 121 and 123 have only one preparatory operation pattern.

In this embodiment, by pre-selecting and setting one preparatory operation pattern from the two preparatory operation patterns the image forming apparatus 110 has, the preparatory operation pattern illustrated in FIG. 16 or the preparatory operation pattern illustrated in FIG. 17 can be performed. In the preparatory operation pattern illustrated in FIG. 16, the preparatory operation of the image forming apparatus 110 is complete at the same time with the preparatory operations of the first and second post-processing units 121 and 123. In the preparatory operation pattern illustrated in FIG. 16, the preparatory operation of the image forming apparatus 110 is complete first to be ready for the photocopying process and thereafter the preparatory operations of the first and second post-processing units 121 and 123 start.

The present invention is not limited to the embodiments and many changes and modifications can be made thereto without departing from the spirit and scope of embodiments of the invention.

In the embodiment firstly mentioned, the preparatory operations of three units, i.e., the center-folding unit G, the punch-hole processing unit A and the stapling unit F, are described. The preparatory operations are not limited thereto and can be applied to another unit (e.g., discharging tray).

In the multiple preparatory operations in the embodiment firstly mentioned, the three preparatory operations of the center-folding unit G, the punch-hole processing unit A and the stapling unit F are simultaneously performed. The preparatory operations of the two (e.g., the center-folding unit G and the punch-hole processing unit A) of the three can be simultaneously performed and, before or after the preparatory operations, the preparatory operation of the rest (e.g., the stapling unit F) can be performed.

In the embodiment firstly mentioned, when each processing unit has at least two parts performing a preparatory operation, it is possible to select a preparatory operation for each part. For example, in the case of the center-folding unit G, it is possible to select a parallel (multiple) preparatory operation or a sequential (separate) preparatory operation for the folding blade 45 and the rear end fence 47 contained in the center-folding unit G.

In the embodiment firstly mentioned, when the power is on for the post-processing unit 100, preparatory operations for each portion thereof are performed. It is also possible to start the preparatory operation when the door is closed or the job is complete.

In the embodiment firstly mentioned, in the case of the sequential preparatory operation, the preparatory operations are performed for the center-folding unit G, the punch-hole processing unit A and the stapling unit F in this order. The preparatory operations therefor can be performed in any order.

This preparatory operation pattern is not only applied to an image formation system but also any unit or apparatus which is connected to peripheral units and performs preparatory operations for the unit or apparatus itself and the peripheral units.

Having now fully described the invention, it will be apparent to one of ordinary skill in the art that many changes and modifications can be made thereto without departing from the spirit and scope of the invention as set forth therein.

Embodiments of the present patent application may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. Embodiments of the present patent application may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that, within the scope of the appended claims, the disclosure of this patent specification may be practiced otherwise than as specifically described herein.

Further, elements and/or features of different example embodiments may be combined with each other and/or substituted for each other within the scope of this disclosure and appended claims.

Still further, any one of the above-described and other example features of the present patent specification may be embodied in the form of an apparatus, method, system, computer program and computer program product. For example, the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMS and DVDS; magneto-optical storage media, such as MOs; magnetic storage media, including but not limited to floppy disks™, cassette tapes, and removable hard disks; media with a built-in rewriteable non-volatile memory, including but not limited to memory cards; and media with a built-in ROM, including but not limited to ROM cassettes, etc. Furthermore, various information regarding stored images, for example, property information, may be stored in any other form, or provided in other ways.

Example embodiments being thus described, it will be obvious that the same may be varied in many ways. Such variations are not to be regarded as a departure from the spirit and scope of the present patent application, and all such modifications as would be obvious to one skilled in the art are intended to be included within the scope of the following claims.

What is claimed is:

1. A peripheral unit, comprising at least one of:
a pre-processing device to perform a pre-processing process; and
a post-processing device to perform a post-processing process,
the peripheral unit being connectable to an image forming apparatus and including multiple preparatory operation patterns in relation to power and time.

2. An image forming apparatus comprising:
a recognition device to recognize a type of a peripheral unit connected to the image forming apparatus,
wherein when at least one peripheral unit of claim 1 is connectable to the image forming apparatus, the image forming apparatus is usable to select a preparatory operation pattern from the multiple preparatory operation patterns for each peripheral unit and is usable to make each peripheral unit perform the preparatory operation therefor.

3. An image forming apparatus comprising:
a recognition device to recognize a type of a peripheral unit connected to the image forming apparatus,
wherein the image forming apparatus includes multiple preparatory operation patterns in relation to power and time, is usable to select a preparatory operation therefrom and is usable to perform the preparatory operation pattern based on types and combinations of peripheral units connected to the image forming apparatus.

4. The image forming apparatus according to claim 2, wherein the image forming apparatus includes preset multiple preparatory operation patterns based on types and combinations of the connected peripheral units, is usable to specify a preparatory operation pattern according to the type and the combination of the peripheral units and is usable to make the peripheral units perform a preparatory operation therefor.

5. An image formation system comprising:
at least one peripheral unit of claim 1.

6. An image formation system comprising:
the image forming apparatus of claim 2.

7. An image formation system comprising:
the image forming apparatus of claims 3.

8. An image formation system comprising:
the image forming apparatus of claim 4.

9. An image forming apparatus comprising:
a recognition device to recognize a type of a peripheral unit connected to the image forming apparatus, wherein when at least one peripheral unit of claim 1 is connectable to the image forming apparatus, the image forming apparatus includes multiple preparatory operation patterns in relation to power and time, is usable to select a preparatory operation therefrom and is usable to perform the preparatory operation pattern based on types and combinations of peripheral units connected to the image forming apparatus.

10. An image formation system comprising:
the image forming apparatus of claim 9.
